(19) United States
(12) Patent Application Publication
(10) Pub. No.: US 2025/0377060 A1
(43) Pub. Date: Dec. 11, 2025

(54) FLUID PIPE AND COOLING DEVICE HAVING THE FLUID PIPE

(71) Applicant: Fulian Precision Electronics (Tianjin) Co., LTD., Tianjin (CN)

(72) Inventors: CHANG-JU WU, New Taipei (TW); CHIH-MIN LIN, New Taipei (TW)

(21) Appl. No.: 18/962,122

(22) Filed: Nov. 27, 2024

(30) Foreign Application Priority Data
Jun. 5, 2024 (CN) 202410724787.X

(51) Int. Cl. F16L 41/14; F28F 9/02; F28F 9/10

(52) U.S. Cl. CPC F16L 41/14; F28F 9/0243; F28F 9/0265; F28F 9/10

(57) ABSTRACT

A fluid pipe and a cooling device having the fluid pipe are disclosed. The fluid pipe of the present application allows the first tubular body to rotate relative to the connecting member and the second tubular body, thereby enabling adjustment of the position of the flow guide member and the second external pipeline connected to the flow guide member. Furthermore, the flow guide member can perform circular motion, the position of the second external pipeline can be further adjusted, facilitating the arrangement of the second external pipeline and reducing bends of the second external pipeline. As such, the length of the second external pipeline can be shortened, the flow rate of fluid within the fluid pipe can be enhanced, and the cooling efficiency can be enhanced.

### FIELD

The subject matter herein generally relates to heat dissipation, and more particularly, to a fluid pipe and a cooling device having the fluid pipe.

### BACKGROUND

Liquid cooling systems are widely used in servers, which are more efficient at heat transfer than air cooling systems. In the current liquid cooling system, the hose barbs of coolant pipes are fixed, so that some of the coolant pipes need to be bent. Thus, the total length of the coolant pipes is increased, and the arrangement of the coolant pipes is complicated.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a diagrammatic view of an embodiment of a fluid pipe according to the present disclosure.

FIG. 2 is a diagrammatic view of the fluid pipe of FIG. 1, viewed from another angle.

FIG. 3 is a diagrammatic view of another embodiment of a fluid pipe according to the present disclosure.

FIG. 4 is a diagrammatic view of yet another embodiment of a fluid pipe according to the present disclosure.

FIG. 5 is a diagrammatic view of yet another embodiment of a fluid pipe according to the present disclosure.

FIG. 6 is a diagrammatic view of an embodiment of a portion of a fluid pipe according to the present disclosure.

FIG. 7 is an exploded view of a partial fluid pipe of the fluid pipe in FIG. 6.

FIG. 8 is similar to FIG. 6, but showing the portion of the fluid pipe viewed from another angle.

FIG. 9 is a diagrammatic view of another embodiment of a portion of a fluid pipe according to the present disclosure.

FIG. 10 is an exploded view of a partial fluid pipe of the fluid pipe in FIG. 9.

FIG. 11 is a diagrammatic view of an embodiment of a cooling device according to the present disclosure.

### DETAILED DESCRIPTION

Unless otherwise defined, all technical and scientific terms used herein have the same meaning as commonly understood by persons skill in the art. The terms used herein are only for the purpose of describing specific embodiments, and not intended to limit the embodiments of the present application.

It should be noted that when a component is referred to as being “fixed on” or “mounted on” another component, it may be directly on the other component or there may also be an intervening component. When a component is considered to be “set on” another component, it may be in direct contact with the other component or there may also be an intervening component.

It is understandable that the term “perpendicular” is used to describe an ideal state between two components. In actual production or use, there can be a state that is approximately perpendicular or equal to perpendicular between the two components. For example, perpendicular can refer to an angle between two lines within the range of 90°±10°, perpendicular can also refer to a dihedral angle between two planes within the range of 90°±10°, and perpendicular can further refer to an angle between a line and a plane within the range of 90°±10°. The two components described as “perpendicular” may not be absolute straight lines or planes, but can approximately resemble straight lines or planes. From a macroscopic perspective, if the overall extension direction is a straight line or plane, the component can be considered as a “straight line” or “plane”.

In the description of the present application, “multiple” means more than one unless expressly and specifically defined otherwise.

Some embodiments of the present application will be described in detail below with reference to the drawings. The following embodiments and features of the embodiments may be combined with each other in the absence of conflict.

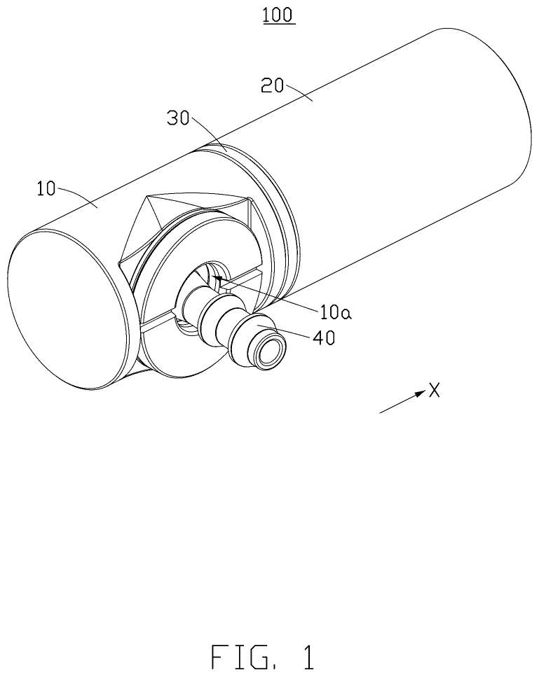

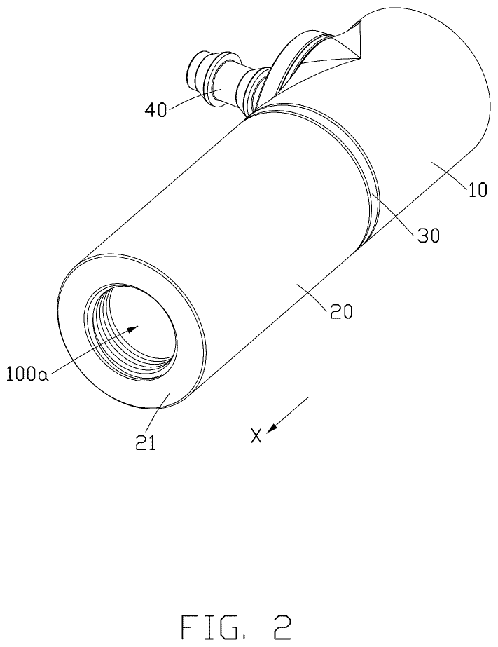

Referring to FIGS. 1 and 2, an embodiment of the present application provides a fluid pipe 100 including a first tubular body 10 and a second tubular body 20. The first tubular body 10 and the second tubular body 20 are arranged along a first direction X. One of the first tubular body 10 and the second tubular body 20 is configured to connect to a first external pipeline.

The fluid pipe 100 further includes a connecting member 30, which is rotatably connected to the first tubular body 10 and fixed to the second tubular body 20. The first tubular body 10 is communicating with the second tubular body 20 through the connecting member 30. The first tubular body 10 is configured to rotate relative to the connecting member 30 and the second tubular body 20 along the circumferential direction of the first tubular body 10.

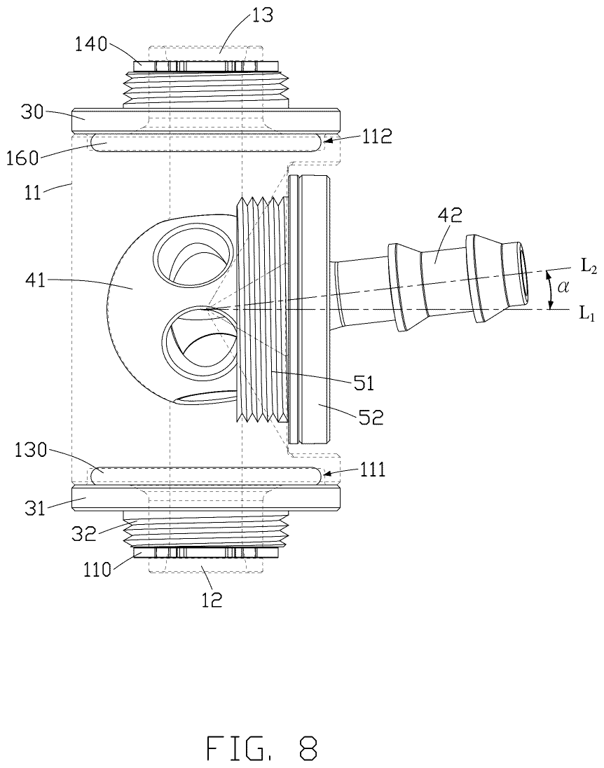

The fluid pipe 100 further includes a flow guide member 40 and defines an opening 10a. The flow guide member 40 is disposed within the first tubular body 10 and extends out of the opening 10a for connecting to a second external pipeline. The flow guide member 40 is communicating with the first tubular body 10 and configured to perform circular motion around the centerline L₁ (referring to FIG. 8) of the opening 10a.

The fluid pipe 100 of the present application allows the first tubular body 10 to rotate relative to the connecting member 30 and the second tubular body 20, thereby enabling adjustment of the position of the flow guide member 40 and the second external pipeline connected to the flow guide member 40. Furthermore, by allowing the flow guide member 40 to perform circular motion around the centerline L₁ (referring to FIG. 8) of the opening 10a, the position of the second external pipeline can be further adjusted, facilitating the arrangement of the second external pipeline and reducing bends of the second external pipeline. As such, the length of the second external pipeline can be shortened, and the flow rate of fluid within the fluid pipe 100 can be enhanced.

In some embodiments, the fluid pipe 100 includes N first tubular body (bodies) 10 and N second tubular body (bodies) 20, wherein N is a natural number greater than or equal to 1.

Referring to FIGS. 1 and 2, the fluid pipe 100 includes one first tubular body 10 and one second tubular body 20. One of the first tubular body 10 and the second tubular body 20 defines a first pipe mouth 100a, while the other of the first tubular body 10 and the second tubular body 20 has a closed end.

In some embodiments, one end of the first tubular body 10 facing away from the second tubular body 20 is closed, and one end of the second tubular body 20 facing away from the first tubular body 10 defines the first pipe mouth 100a configured for connecting to the first external pipeline. The second tubular body 20 includes a second tube wall 21, and the first pipe mouth 100a penetrates the second tube wall 21.

In other embodiments, one end of the first tubular body 10 facing away from the second tubular body 20 defines the first pipe mouth 100a for connecting to the first external pipeline, while one end of the second tubular body 20 facing away from the first tubular body 10 is closed.

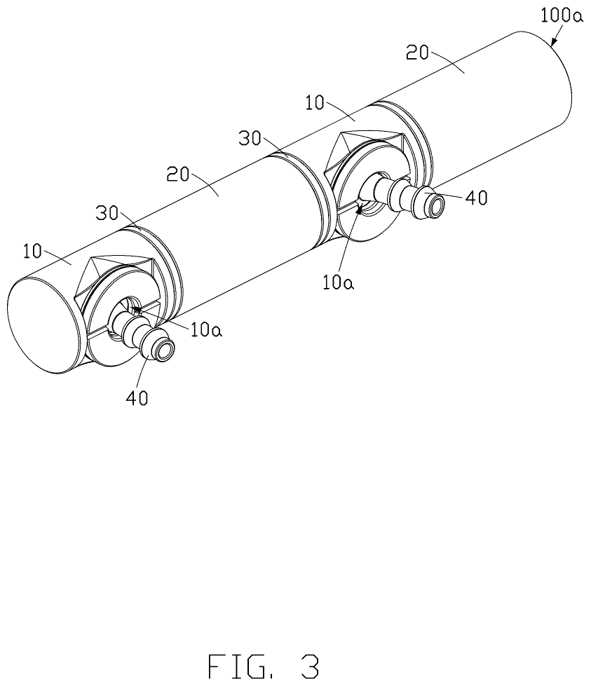

Referring to FIG. 3, the fluid pipe 100 includes two first tubular bodies 10 and two second tubular bodies 20. The two first tubular bodies 10 and the two second tubular bodies 20 are alternately spaced apart. Along the first direction X, one of the outermost first tubular body 10 and the outermost second tubular body 20 of the fluid pipe 100 defines the first pipe mouth 100a, and the other of the outermost first tubular body 10 and the outermost second tubular body 20 is closed.

In some embodiments, one end of the outermost first tubular body 10 facing away from the second tubular body 20 is closed, and one end of the outermost second tubular body 20 facing away from the first tubular body 10 defines the first pipe mouth 100a for connecting to the first external pipeline. The outermost second tubular body 20 includes the second tube wall 21, and the first pipe mouth 100a penetrates the second tube wall 21.

In other embodiments, one end of the outermost first tubular body 10 facing away from the second tubular body 20 defines the first pipe mouth 100a for connecting to the first external pipeline, and one end of the outermost second tubular body 20 facing away from the first tubular body 10 is closed.

In some embodiments, the fluid pipe 100 includes N first tubular body (bodies) 10 and N+1 second tubular bodies 20, wherein Nis a natural number greater than or equal to 1. Each of the first tubular bodies 10 is positioned between adjacent second tubular bodies 20.

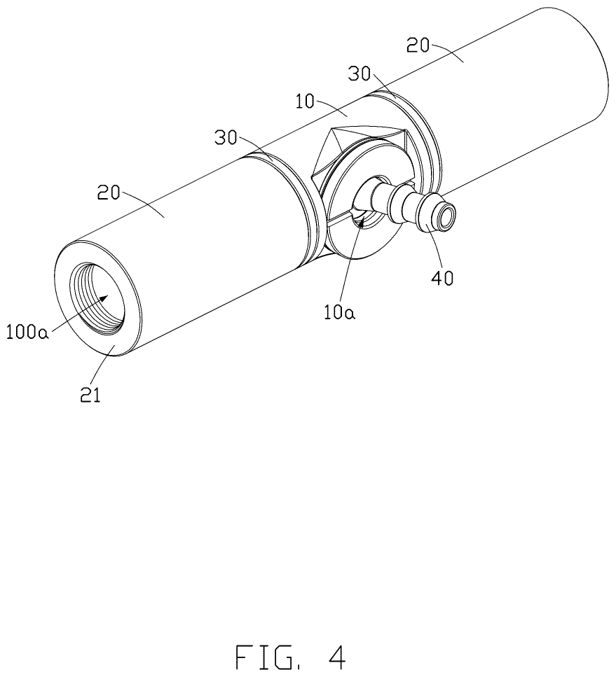

Referring to FIG. 4, the fluid pipe 100 includes one first tubular body 10 and two second tubular bodies 20. The one first tubular body 10 is connected to the two second tubular bodies 20 through two connecting members 30. The two second tubular bodies 20 are located at the outermost sides of the fluid pipe 100. One of the two second tubular bodies 20 defines the first pipe mouth 100a, while the other of the two second tubular bodies 20 is closed.

In some embodiments, the fluid pipe 100 includes N+1 first tubular bodies 10 and N second tubular body (bodies) 20, wherein Nis a natural number greater than or equal to 1. Each of the second tubular bodies 20 is positioned between adjacent first tubular bodies 10.

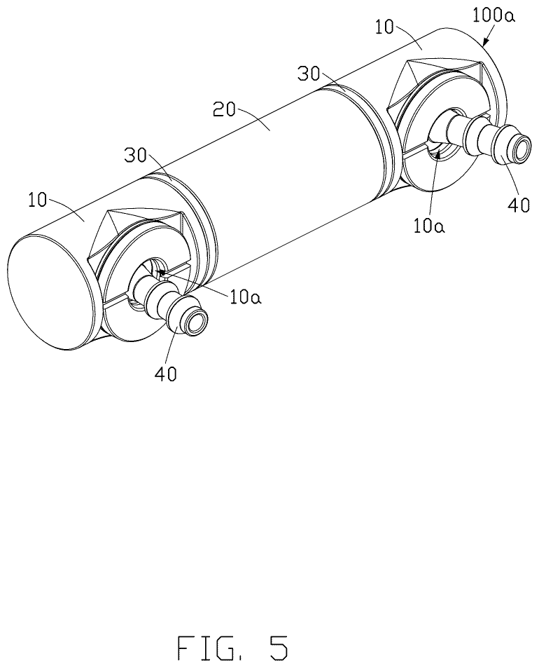

Referring to FIG. 5, the fluid pipe 100 includes two first tubular bodies 10 and one second tubular body 20. The one second tubular body 20 is connected to the two first tubular bodies 10 through two connecting members 30. The two first tubular bodies 10 are located at the outermost sides of the fluid pipe 100. One of the two first tubular bodies 10 defines the first pipe mouth 100a, and the other of the two first tubular bodies 10 is closed.

It is understood that the number of the first tubular bodies 10 and the second tubular bodies 20 can be adjusted according to requirements and is not limited to the quantities specified in the aforementioned embodiments.

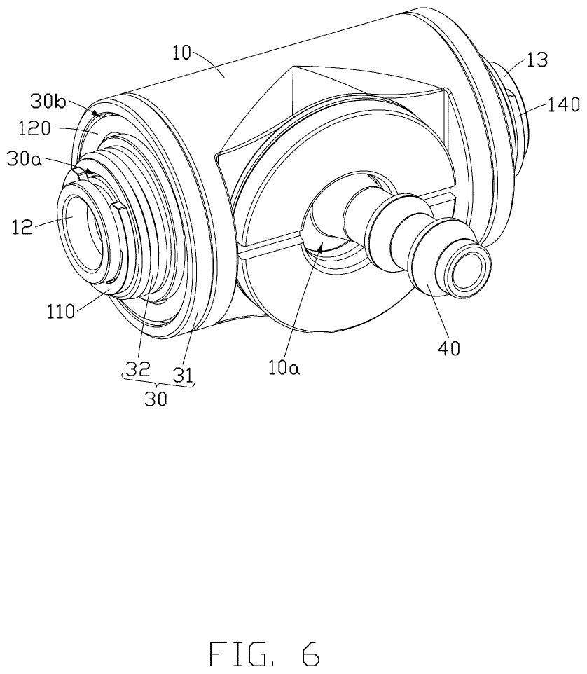

Referring to FIGS. 6, 7, and 10, in some embodiments, the connecting member 30 includes a connecting body 31 and a connecting protrusion 32 fixed to the connecting body 31. The connecting protrusion 32 is located on the side of the connecting body 31 facing away from the first tubular body 10. The connecting protrusion 32 is used for fixedly connecting the second tubular body 20. A portion of the first tubular body 10 passes through the connecting body 31 and the connecting protrusion 32, and extends into the second tubular body 20.

In some embodiments, the connecting body 31 and the connecting protrusion 32 are integrally formed.

In some embodiments, the connecting protrusion 32 is provided with external threads, and the second tubular body 20 is provided with internal threads. The connecting protrusion 32 is threadedly connected to the second tubular body 20.

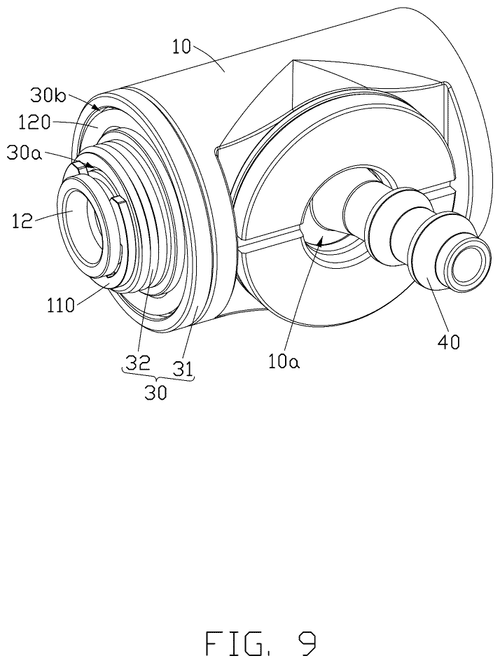

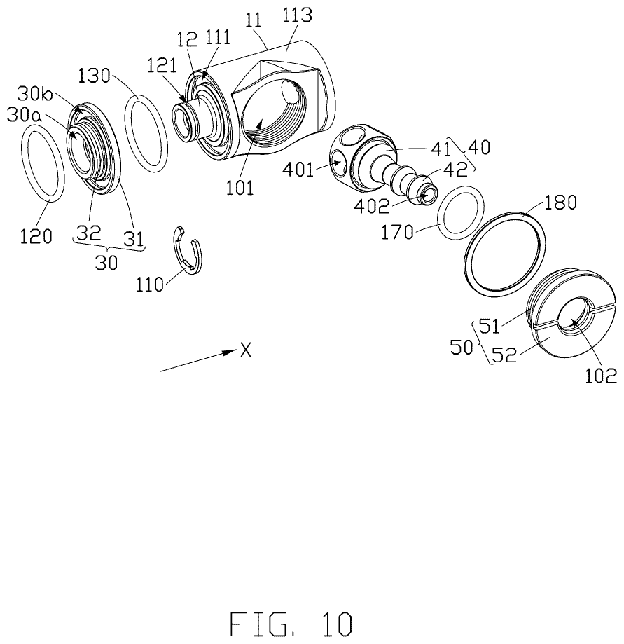

Referring to FIGS. 9 and 10, in some embodiments, the first tubular body 10 includes a main body 11 and a first protrusion 12. The first protrusion 12 is connected to the main body 11, and the first protrusion 12 and the first main body 11 are arranged along the first direction X.

In some embodiments, the main body 11 and the first protrusion 12 are integrally formed.

In some embodiments, the connecting member 30 defines a first opening 30a penetrating the connecting body 31 and the connecting protrusion 32. The first protrusion 12 passes through the first opening 30a and is disposed inside the second tubular body 20. The connecting body 31 is located between the main body 11 and the adjacent second tubular body 20, allowing the first tubular body 10 to rotate relative to the connecting member 30 and the second tubular body 20 along the circumferential direction of the first tubular body 10, thereby adjusting the flow guide member 40 to any position in the circumferential direction.

In some embodiments, the fluid pipe 100 further includes a first limiting member 110. The first protrusion 12 defines a first groove 121, and the first limiting member 110 is disposed in the first groove 121. Along the first direction X, the connecting member 30 is located between the first limiting member 110 and the main body 11. The limiting member 110 can limit the movement of the connecting member 30 to reduce the risk of the connecting member 30 detaching from the first protrusion 12, and thus lowering the risk of fluid leakage due to the separation between the first tubular body 10 and the second tubular body 20.

In some embodiments, the fluid pipe 100 further includes a first sealing member 120. The side of the connecting body 31 facing the second tubular body 20 defines a first receiving groove 30b, and the first sealing member 120 is disposed in the first receiving groove 30b. The first sealing member 120 contacts and connects the second tubular body 20 and the connecting body 31, which helps reduce the leakage between the second tubular body 20 and the connecting member 30.

In some embodiments, the fluid pipe 100 further includes a second sealing member 130. The side of the main body 11 facing the connecting member 30 defines a second receiving groove 111, and the second sealing member 130 is disposed in the second receiving groove 111. The second sealing member 130 contacts and connects the main body 11 and the connecting body 31, which helps reduce the leakage between the first tubular body 10 and the connecting member 30.

Referring to FIGS. 6 to 8, in some embodiments, the first tubular body 10 further includes a second protrusion 13. The second protrusion 13 is connected to the main body 11, and the main body 11 and the second protrusion 13 are arranged along the first direction X. The first protrusion 12 and the second protrusion 13 are connected to the opposite sides of the main body 11 respectively.

In some embodiments, the main body 11 and the second protrusion 13 are integrally formed.

In some embodiments, the second protrusion 13 passes through the first opening 30a of another adjacent connecting member 30 and is disposed within an adjacent second tubular body 20. The connecting body 31 of the another adjacent connecting member 30 is located between the main body 11 and the another adjacent second tubular body 20, allowing the first tubular body 10 to rotate relative to the two connecting members 30 and the two second tubular body 20 along the circumferential direction of the first tubular body 10.

In some embodiments, the fluid pipe 100 further includes a second limiting member 140. The second protrusion 13 defines a second groove 131, and the second limiting member 140 is disposed within the second groove 131. Along the first direction X, the connecting member 30 is located between the main body 11 and the second limiting member 140. The second limiting member 140 can limit the movement of the connecting member 30 to reduce the risk of the connecting member 30 detaching from the second protrusion 13, and thus reducing fluid leakage due to the separation between the first tubular body 10 and the adjacent second tubular body 20.

In some embodiments, the fluid pipe 100 further includes a third sealing member 150 disposed within the first receiving groove 30b of another connecting body 31. The third sealing member 150 contacts and connects the adjacent another second tubular body 20 and the another connecting member 30, thereby reducing the leakage between the second tubular body 20 and the connecting member 30.

In some embodiments, the fluid pipe 100 further includes a fourth sealing member 160. One end of the main body 11 connecting to the second protrusion 13 defines a third receiving groove 112, and the fourth sealing member 160 is disposed within the third receiving groove 112. The fourth sealing member 160 contacts and connects the main body 11 and another connecting member 30, thereby reducing the leakage between the first tubular body 10 and the another connecting member 30.

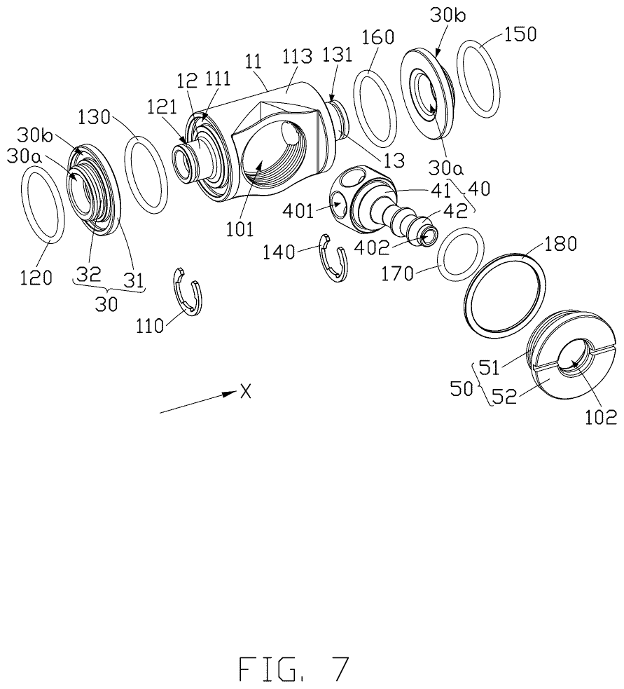

Referring to FIGS. 7 and 10, in some embodiments, the main body 11 includes a first tube wall 113. The opening 10a includes a second opening 101 penetrating the first tube wall 113. A portion of the flow guide member 40 is disposed within the main body 11, another portion of the flow guide member 40 is sealingly connected to the second opening 101, and the remaining portion of the flow guide member 40 extends out of the second opening 101. The flow guide member 40 can perform circular motions around the centerline L₁ of the second opening 101.

In some embodiments, the fluid pipe 100 further includes a connecting element 50. The opening 10a includes the second opening 101 and a third opening 102. The second opening 101 penetrates the first tube wall 113, and the third opening 102 penetrates the connecting element 50. The connecting element 50 is connected to the second opening 101, and the flow guide member 40 extends out of the connecting element 50 through the third opening 102.

In some embodiments, the second opening 101 and the third opening 102 are concentrically arranged. That is, the second opening 101 and the third opening 102 share the same centerline L₁. The flow guide member 40 can perform circular motions around the centerline L₁ of the second opening 101 and the third opening 102, allowing the flow guide member 40 to be adjusted to any position along the circumferential direction.

In some embodiments, the flow guide member 40 includes a first channel opening 401 and a second channel opening 402. The first channel opening 401 communicates with the main body 11, and the second channel opening 402 is used to communicate with the second external pipeline.

In some embodiments, the flow guide member 40 includes a first section 41 disposed within the main body 11. The first section 41 defines multiple first channel openings 401. Fluid may enter through the first channel openings 401 and exit through the second channel opening 402, or the fluid may enter through the second channel opening 402 and exit through the first channel openings 401, which is beneficial for increasing the fluid flow rate.

Furthermore, the flow guide member 40 also includes a second section 42 communicating with the first section 41. The second section 42 extends out of the connecting element 50 through the third opening 102, and the second channel opening 402 is defined on the second section 42.

Referring to FIG. 8, in some embodiments, the centerline L₂ of the flow guide member 40 forms an angle α with the centerline L₁ of the opening 10a, wherein 0°≤α≤15°, which is beneficial for adjusting the position of the flow guide member 40 along the circumferential direction of the centerline.

In some embodiments, α may be any one of 0°, 1°, 2°, 3°, 4°, 5°, 6°, 7°, 8°, 9°, 10°, 11°, 12°, 13°, 14°, and 15°.

In some embodiments, the circle formed by the first tubular body 10 rotating along its own circumferential direction is defined as the first circle, and the circle formed by the flow guide member 40 moving circumferentially around the centerline L₁ of the opening 10a is defined as the second circle. The first circle defines a first plane, and the second circle defines a second plane. The first plane is perpendicular to the second plane, which facilitates multi-dimensional adjustment of the position of the flow guide member 40, facilitates the arrangement of the second external pipeline, helps reduce bending of the second external pipeline, shortens the length of the second external pipeline, and enhances the flow rate of fluid within the fluid pipe 100.

In some embodiments, the connecting element 50 includes a first connecting portion 51 and a second connecting portion 52 connected to the first connecting portion 51. The first connecting portion 51 connects to the second opening 101.

Furthermore, the first connecting portion 51 is connected to the main body 11 through threads.

In some embodiments, the fluid pipe 100 further includes a fifth sealing member 170 disposed between the first section 41 and the first connecting portion 51. The fifth sealing member 170 contacts and connects the first section 41 and the first connecting portion 51, reducing the leakage between the first tubular body 10 and the flow guide member 40.

In some embodiments, the fluid pipe 100 further includes a sixth sealing member 180 sleeved over the first connecting portion 51 and disposed between the second connecting portion 52 and the first tube wall 113. The sixth sealing member 180 contacts and connects the second connecting portion 52 and the first tube wall 113, reducing the likelihood of leakage between the first tubular body 10 and the connecting element 50.

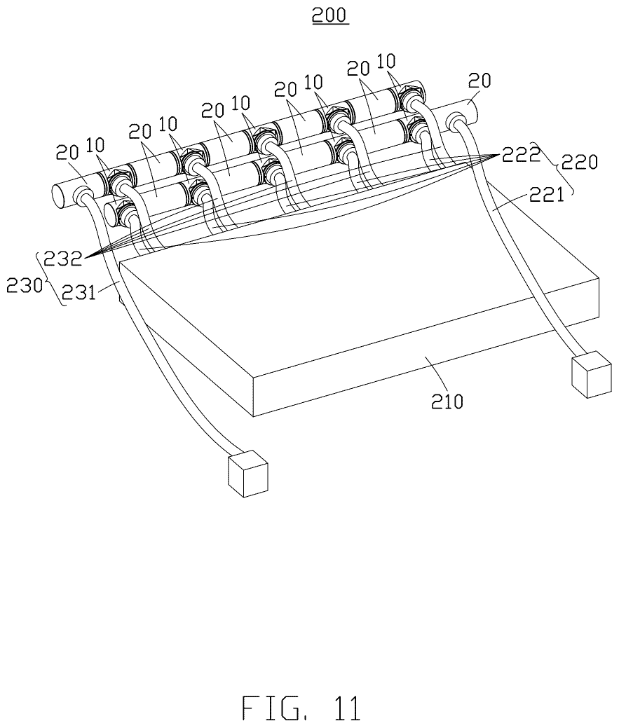

Referring to FIG. 11, an embodiment of the present application further provides a cooling device 200. The cooling device 200 includes a cooling element 210, a first pipeline 220, a second pipeline 230, and two fluid pipes 100 from any of the aforementioned embodiments.

In some embodiments, the cooling element 210 includes an inlet (not shown) and an outlet (not shown). Fluid enters the cooling element 210 through the inlet and exits through the outlet. The fluid can carry away heat from components installed on the cooling element 210, thereby cooling the components. The fluid may be a liquid or a gas.

In some embodiments, the cooling element 210 is a liquid-cooled plate.

In some embodiments, multiple cooling elements 210 are arranged along the first direction X.

In some embodiments, the cooling element 210 may install processors, motherboards, power supplies, and other related electronic components.

In some embodiments, the first pipeline 220 includes a first main pipeline 221 and a first branch pipeline 222. The first main pipeline 221 communicates with one of the fluid pipes 100, and the first branch pipeline 222 communicates with the flow guide member 40 of that fluid pipe 100 and the inlet of the cooling element 210.

In some embodiments, the second pipeline 230 includes a second main pipeline 231 and a second branch pipeline 232. The second main pipeline 231 communicates with the other fluid pipe 100, and the second branch pipeline 232 communicates with the flow guide member 40 of that fluid pipe 100 and the outlet of the cooling element 210.

In some embodiments, there are multiple first branch pipelines 222 and second branch pipelines 232. Each first branch pipeline 222 is connected to the cooling element 210, and each second branch pipeline 232 is connected to the cooling element 210.

When the cooling device 200 is in use, an external device directs the fluid into the fluid pipe 100 through the first main pipeline 221. The fluid then passes through the flow guide member 40 of that fluid pipe 100 and the first branch pipeline 222 into the cooling element 210. Then, the fluid flows out of the cooling element 210 and into the second branch pipeline 232. The second branch pipeline 232 guides the fluid to another fluid pipe 100, and the fluid flows into the external devices through the second main pipeline 231 of that fluid pipeline. The above process is repeated to dissipate heat from the components installed on the cooling element 210.

In the aforementioned cooling device 200, the position of the flow guide member 40 can be adjusted in multiple dimensions, allowing for flexible arrangement of the first branch pipelines 222 and the second branch pipelines 232. The multiple dimensions adjustment of the flow guide member 40 also minimizes the bending of both the first and second branch pipelines 222, 232, thereby shortening the total lengths of the first and second branch pipelines 222, 232, and enhancing the flow rate of the fluid and ultimately improving cooling efficiency.

The above descriptions are some specific embodiments of the present application, but the actual application process cannot be limited only to these embodiments. For those of ordinary skill in the art, other modifications and changes made according to the technical concept of the present application should all belong to the protection scope of the present application.

What is claimed is:

1. A fluid pipe comprising:
a first tubular body defining an opening;
a second tubular body, wherein the first tubular body and the second tubular body are arranged along a first direction, and one of the first tubular body and the second tubular body is configured for connecting to a first external pipeline;
a connecting member rotatably connected to the first tubular body and fixed to the second tubular body, wherein the first tubular body communicates with the second tubular body through the connecting member, and the first tubular body is rotatable in a circumferential direction of the first tubular body relative to the connecting member and to the second tubular body; and
a flow guide member arranged in the first tubular body and protrudes from the opening, and configured for connecting to a second external pipeline, the flow guide member communicating with the first tubular body and further configured to perform a circular motion around a centerline of the opening.

2. The fluid pipe of claim 1, wherein the connecting member comprises a connecting body and a connecting protrusion fixed to the connecting body, the connecting protrusion is located on a side of the connecting body facing away from the first tubular body, a portion of the first tubular body extends through the connecting body and the connecting protrusion, and the portion of the first tubular body further extends into the second tubular body.

3. The fluid pipe of claim 2, wherein the first tubular body comprises a main body and a first protrusion connecting to the main body, the first protrusion and the first main body are arranged along the first direction; the connecting member defines a first opening penetrating the connecting body and the connecting protrusion, the first protrusion extends through the first opening, and the connecting body is located between the main body and the second tubular body.

4. The fluid pipe of claim 3, further comprising a first limiting member, wherein the first protrusion defines a first groove, and the first limiting member is arranged in the first groove.

5. The fluid pipe of claim 3, wherein the first tubular body further comprises a second protrusion connected to a side of the main body facing away from the first protrusion, the main body and the second protrusion are arranged along the first direction, the second protrusion extends through the first opening of the connecting member, and the connecting body is located between the main body and the second tubular body.

6. The fluid pipe of claim 5, further comprising a second limiting member, wherein the second protrusion defines a second groove, and the second limiting member is arranged in the second groove.

7. The fluid pipe of claim 3, further comprising a connecting element, wherein the main body comprises a first tube wall, the opening comprises a second opening penetrating the first tube wall and a third opening penetrating the connecting element, the connecting element is connected to the second opening; the flow guide member protrudes from the connecting element through the third opening, the flow guide member comprises a first channel opening and a second channel opening, the first channel opening communicates with the main body, and the second channel opening is configured for communicating with the second external pipeline.

8. The fluid pipe of claim 7, wherein the flow guide member comprises a first section and a second section communicating with the first section, the first section is arranged in the main body, the second section protrudes from the connecting element through the third opening, and the first section defines multiple first channel opening.

9. The fluid pipe of claim 2, further comprising a first sealing member, wherein a side of the connecting body facing the second tubular body defines a first receiving groove, and the first sealing member is arranged in the first receiving groove.

10. The fluid pipe of claim 1, further comprising a second sealing member, wherein a side of the first tubular body facing the connecting member defines a second receiving groove, and the second sealing member is arranged in the second receiving groove.

11. The fluid pipe of claim 1, wherein a centerline of the flow guide member and the centerline of the opening define an angle α, and 0°≤α≤15°.

12. The fluid pipe of claim 1, comprising at least one first tubular body and at least one second tubular body, and a quantity of the at least one tubular body is equal to a quantity of the at least one second tubular body.

13. The fluid pipe of claim 1, comprising at least one first tubular body and at least one second tubular body, and a quantity of the at least one tubular body is less than a quantity of the at least one second tubular body.

14. The fluid pipe of claim 1, comprising at least one first tubular body and at least one second tubular body, and a quantity of the at least one tubular body is greater than a quantity of the at least one second tubular body.

15. A cooling device comprising:
two fluid pipes, each of the two fluid pipe comprising:
a first tubular body defining an opening;
a second tubular body, wherein the first tubular body and the second tubular body are arranged along a first direction;
a connecting member rotatably connected to the first tubular body and fixed to the second tubular body, wherein the first tubular body communicates with the second tubular body through the connecting member, and the first tubular body is rotatable in a circumferential direction of the first tubular body relative to the connecting member and to the second tubular body; and
a flow guide member arranged in the first tubular body and protrudes from the opening, and the guide member communicating with the first tubular body and is configured to perform a circular motion around a centerline of the opening;
a cooling element;
a first pipeline comprising a first main pipeline and a first branch pipeline, wherein the first main pipeline communicates with one of the two fluid pipes, and the first branch pipeline communicates with the flow guide member of the one of the two fluid pipes and the cooling element; and
a second pipeline comprising a second main pipeline and a second branch pipeline, wherein the second main pipeline communicates with another of the two fluid pipes, and the second branch pipeline communicates with the flow guide member of the another of the two fluid pipes and the cooling element.

16. The fluid pipe of claim 15, wherein the connecting member comprises a connecting body and a connecting protrusion fixed to the connecting body, the connecting protrusion is located on a side of the connecting body facing away from the first tubular body, a portion of the first tubular body extends through the connecting body and the connecting protrusion, and the portion of the first tubular body further extends into the second tubular body.

17. The fluid pipe of claim 16, wherein the first tubular body comprises a main body and a first protrusion connecting to the main body, the first protrusion and the first main body are arranged along the first direction; the connecting member defines a first opening penetrating the connecting body and the connecting protrusion, the first protrusion extends through the first opening, and the connecting body is located between the main body and the second tubular body.

18. The fluid pipe of claim 17, wherein the fluid pipe further comprises a first limiting member, the first protrusion defines a first groove, and the first limiting member is arranged in the first groove.

19. The fluid pipe of claim 17, wherein the first tubular body further comprises a second protrusion connected to a side of the main body facing away from the first protrusion, the main body and the second protrusion are arranged along the first direction, the second protrusion extends through the first opening of the connecting member, and the connecting body is located between the main body and the second tubular body.

20. The fluid pipe of claim 19, wherein the fluid pipe further comprises a second limiting member, the second protrusion defines a second groove, and the second limiting member is arranged in the second groove.
